(19) United States
(12) Patent Application Publication
(10) Pub. No.: US 2026/0194100 A1
(43) Pub. Date: Jul. 9, 2026

(54) ADJUSTABLE VEHICLE FASTENER ASSEMBLY

(71) Applicant: Ford Global Technologies, LLC, Dearborn, MI (US)

(72) Inventors: Kevin Lagerstrom, Livonia, MI (US); Christopher Michael Deptula, West Bloomfield, MI (US); Luis Islas Quintana, Mexico City (MX)

(21) Appl. No.: 19/008,927

(22) Filed: Jan. 3, 2025

(51) Int. Cl. F16B 21/07; B60R 13/04

(52) U.S. Cl. CPC F16B 21/073; B60R 13/04

(57) ABSTRACT

An adjustable fastener assembly includes a grommet base and a grommet insert having a socket. The socket holds a stud to secure the stud relative to the grommet insert. The grommet insert is adjustable relative to the grommet base between a plurality of fixed positions. The grommet base can include grommet teeth that interlock or mesh with insert teeth of the grommet insert to hold the grommet insert in one of the fixed positions.

### TECHNICAL FIELD

This disclosure relates generally to a fastener used to secure together components of a vehicle and, more particularly, to a hands-free fastener that is adjustable.

### BACKGROUND

Vehicles include fasteners to attach various components. Some fasteners include a grommet and a stud. The grommet can be mounted to a first component, such as a body structure of the vehicle. The stud can be secured to a second component, such as a trim panel. The grommet receives and holds the stud to secure the second component relative to first component. This type of fastener can be considered a hands-free fastener as direct access to the fastener is not required during engagement. Some such hands-free fasteners permit the stud to freely slide relative to the grommet

### SUMMARY

In some aspects, the techniques described herein relate to an adjustable fastener assembly, including: a grommet base; and a grommet insert having a socket that holds a stud to secure the stud relative to the grommet insert, the grommet insert adjustable relative to the grommet base between a plurality of fixed positions.

In some aspects, the techniques described herein relate to an adjustable fastener assembly, wherein the grommet base includes a plurality of base teeth and the grommet insert includes a plurality of insert teeth, the plurality of base teeth interlocking with the plurality of insert teeth to hold the grommet insert in one of the plurality of fixed positions.

In some aspects, the techniques described herein relate to an adjustable fastener assembly, wherein one of the plurality of insert teeth or the plurality of base teeth is biased into engagement with the other of the plurality of insert teeth or the plurality of base teeth.

In some aspects, the techniques described herein relate to an adjustable fastener assembly, wherein the grommet insert is slidably adjustable relative to the grommet base.

In some aspects, the techniques described herein relate to an adjustable fastener assembly, wherein the socket receives the stud in a first direction, wherein the grommet insert is slidably adjustable relative to the grommet base in a second direction that is transverse to the first direction.

In some aspects, the techniques described herein relate to an adjustable fastener assembly, wherein the stud is secured to a first component of a vehicle, wherein the grommet base and the grommet insert are secured to a second component of the vehicle, wherein the socket holding the stud secures the first component relative to the second component.

In some aspects, the techniques described herein relate to an adjustable fastener assembly, wherein the first component is a trim panel.

In some aspects, the techniques described herein relate to an adjustable fastener assembly, wherein the second component is a body panel of a vehicle.

In some aspects, the techniques described herein relate to an adjustable fastener assembly, wherein the body panel is a liftgate body panel.

In some aspects, the techniques described herein relate to an adjustable fastener assembly, wherein the grommet base is snap-fit within an aperture of the body panel.

In some aspects, the techniques described herein relate to an adjustable fastener assembly, wherein a plurality of interlocking features of the grommet base are configured to interlock with a plurality of interlocking features of the grommet insert to hold the grommet insert in one of the plurality of fixed positions.

In some aspects, the techniques described herein relate to an adjustable fastener assembly, wherein the grommet base includes at least one groove that slidably receives the grommet insert.

In some aspects, the techniques described herein relate to an adjustable fastener assembly, including: a grommet assembly secured to a first component, the grommet assembly having a grommet base holding a grommet insert, the grommet insert slidable relative to the grommet base when the grommet insert is held by the grommet base, the grommet insert having a plurality of insert interlocking features that engage a plurality of base interlocking features to block sliding of the grommet insert relative to the grommet base; and a stud secured to a second component, the stud held within a socket of the grommet insert and slidable with the grommet insert relative to the grommet base.

In some aspects, the techniques described herein relate to an adjustable fastener assembly, wherein the plurality of insert interlocking features are a plurality of insert teeth, and the plurality of base interlocking features are a plurality of base teeth.

In some aspects, the techniques described herein relate to an adjustable fastener assembly, wherein the stud is a ball stud.

In some aspects, the techniques described herein relate to an adjustable fastener assembly, wherein the grommet base is snap-fit to the first component.

In some aspects, the techniques described herein relate to an adjustable fastener assembly, wherein the plurality of insert interlocking features and the plurality of base interlocking features are biased into engagement with each other.

In some aspects, the techniques described herein relate to an adjustable fastener assembly, wherein the plurality of insert interlocking features and the plurality of base interlocking features are disengaged when the grommet insert slides relative to the grommet base.

In some aspects, the techniques described herein relate to an adjustable fastener assembly, wherein the grommet insert and the stud are slidable relative to the grommet base in a direction that is transverse to a longitudinal axis of the stud.

In some aspects, the techniques described herein relate to an adjustable fastener assembly, wherein the first component is an exterior trim panel of a vehicle.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a rear view of a vehicle with a trim panel of a liftgate detached.

FIG. 2 illustrates the rear view of FIG. 1 with the trim panel attached.

FIG. 3 illustrates a rear perspective view of the vehicle of FIG. 2 with the liftgate partially opened.

FIG. 4 illustrates a perspective view of an adjustable fastener assembly that attaches the trim panel.

FIG. 5 illustrates a front view of a grommet assembly of the adjustable fastener assembly of FIG. 4 with a grommet insert of the grommet assembly in a fixed position relative to a grommet base of the grommet assembly.

FIG. 6 illustrates a front view of a grommet insert of the grommet assembly of FIG. 5.

FIG. 7 illustrates a section view taken at line 7–7 in FIG. 6.

FIG. 8 illustrates a front view of a grommet base of the grommet assembly of FIG. 5.

FIG. 9 illustrates a section view taken at line 8–8 in FIG. 8.

FIG. 10 illustrates the front view of FIG. 5 with the grommet insert adjusted relative to the grommet base to another fixed position.

FIG. 11 illustrates the front view of FIG. 5 with the grommet insert adjusted relative to the grommet base to yet another fixed position.

FIG. 12 illustrates a perspective view of a grommet assembly from an adjustable fastener assembly according another exemplary embodiment of the present disclosure.

### DETAILED DESCRIPTION

This disclosure details exemplary fastener assemblies that are used to attach together components of a vehicle. The fastener assemblies can be adjustable to a plurality of different fixed positions. The adjustability can help to align the attached components relative to each other.

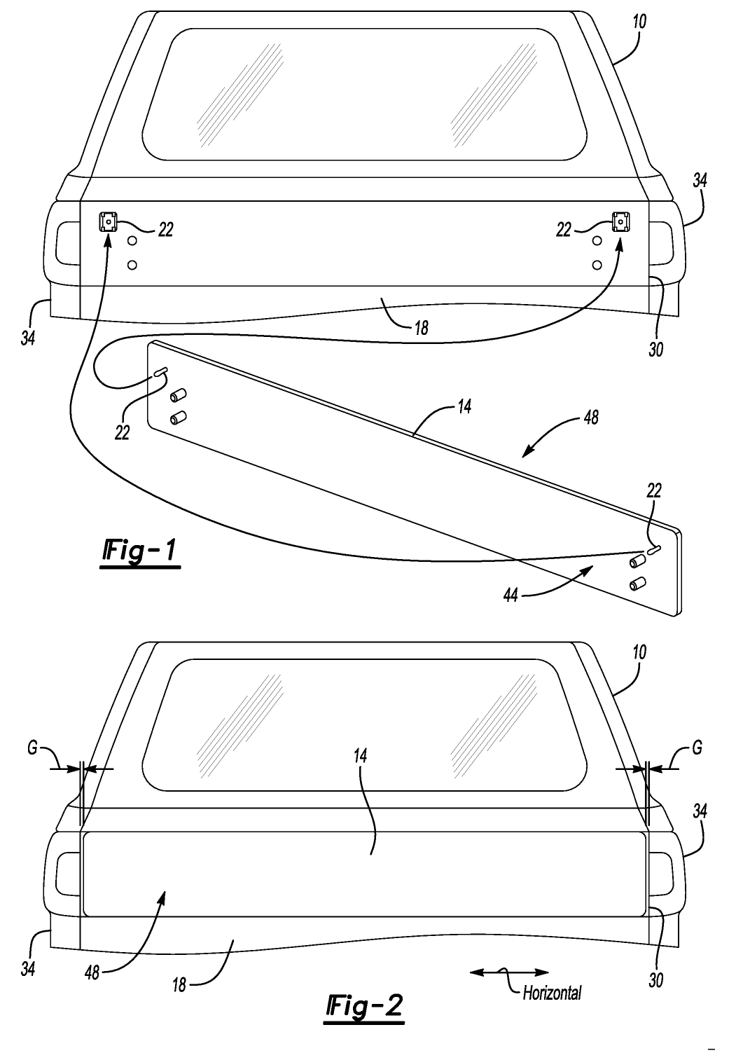

With reference to FIGS. 1-4, a vehicle 10 includes a first component 14 secured to a second component 18 with a plurality of fastener assemblies 22. In the exemplary embodiment, the fastener assemblies 22 are slidable adjustable to between a plurality of fixed positions. The adjustability of the fastener assemblies 22 allows a position of the first component 14 to be adjusted relative to the second component 18, which can be desirable to, among other things, control a size of gaps G between the first component 14 and other areas of the vehicle 10.

In this example, the first component 14 is an exterior trim panel of the vehicle 10 and, more specifically, an exterior trim panel of a liftgate 30 of the vehicle 10. The exterior trim panel can be a polymer-based trim panel. In this example, the second component 18 is a vehicle body panel – here a body panel of the liftgate 30. The body panel can be a metal or metal alloy.

The gaps G are at opposing lateral sides of the first component 14 between the first component 14 and D-pillars 34 of the vehicle 10 when the first component 14 is secured to the second component 18. Horizontal adjustments to a position of the first component 14 relative to the second component 18 can change a size of the gaps G. Adjustments can be desired to make the gaps G substantially consistent and to make the first component 14 appear centered. The example fastener assembles 22 permit such adjustments. Horizontal, for purposes of this disclosure, is with reference to ground and a general orientation of the vehicle 10 during operation.

In this example, during assembly, the first component 14 is moved from the position of FIG. 1, where the fastener assemblies 22 are disengaged, to the position of FIG. 2 where the fastener assemblies 22 are engaged. The first component 14 is then, if required, shifted horizontally to change a size of the gaps G.

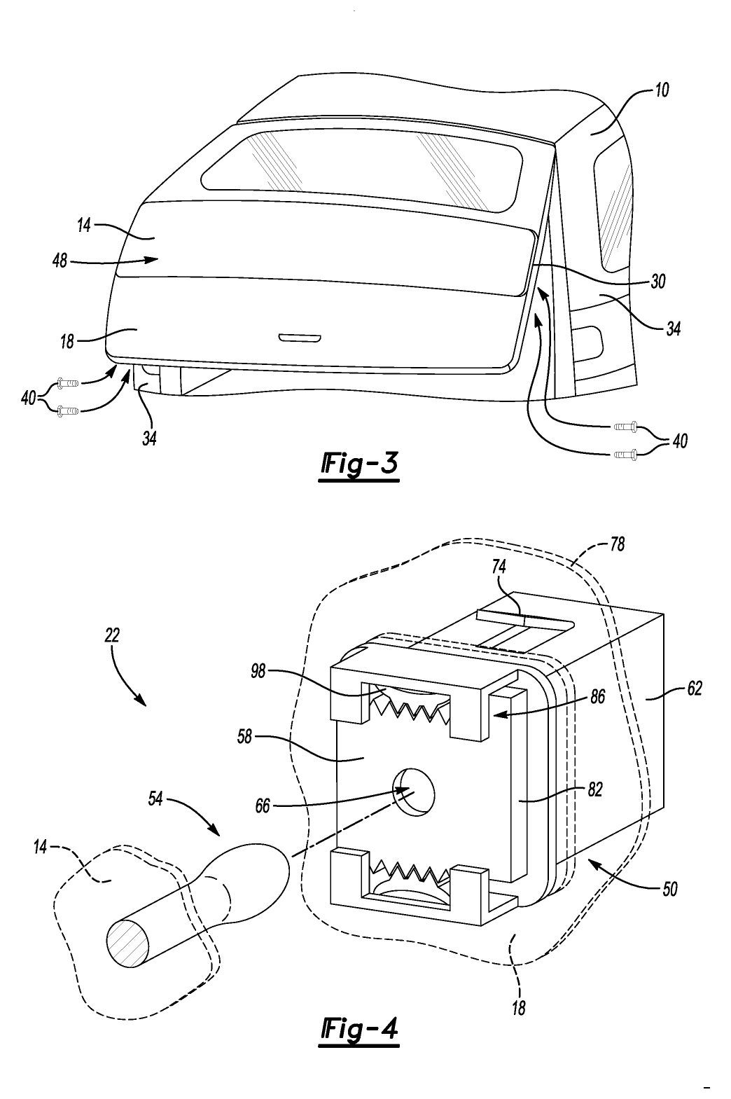

When the first component 14 is in a desired position where the gaps G are a desired size, the liftgate 30 can be opened while the fastener assemblies 22 continue to hold the first component 14 in the desired position as shown in FIG. 3. A plurality of threaded fasteners 40 are then used to fix the first component 14 in the desired position. The threaded fasteners 40 can engage with insert nuts attached to a B-side 44 of the first component 14.

The B-side 44 is hidden from view when the first component 14 is attached to the second component. An A-side 48 of the first component 14 is visible when the vehicle 10 is viewed from an area behind the vehicle 10.

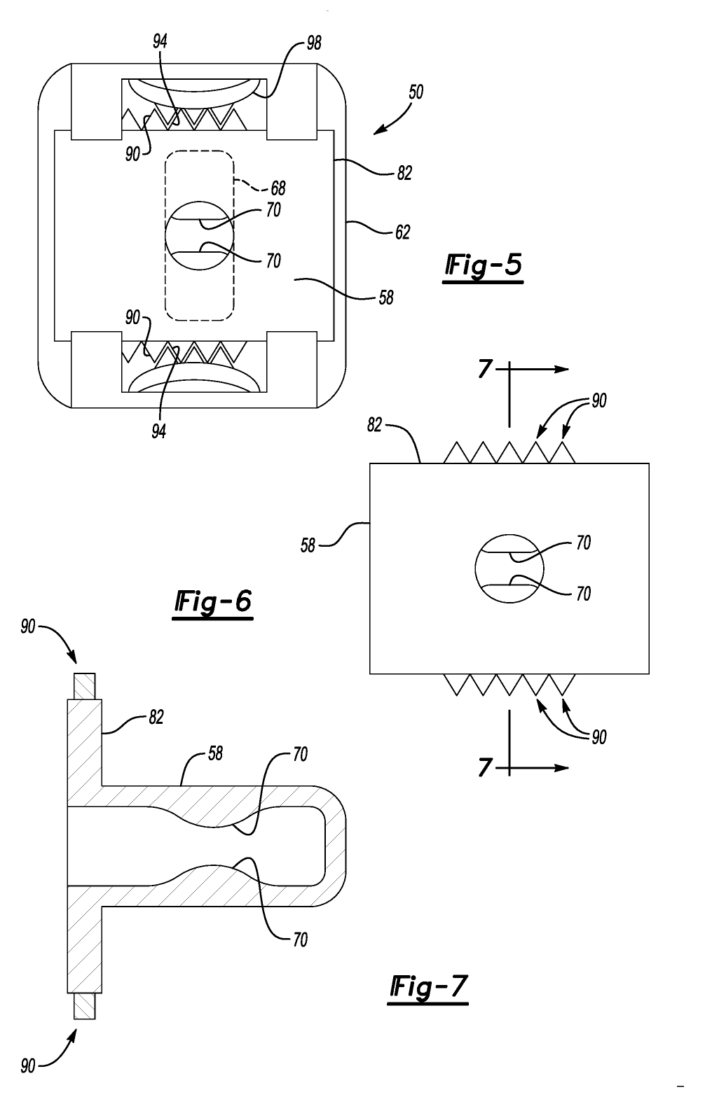

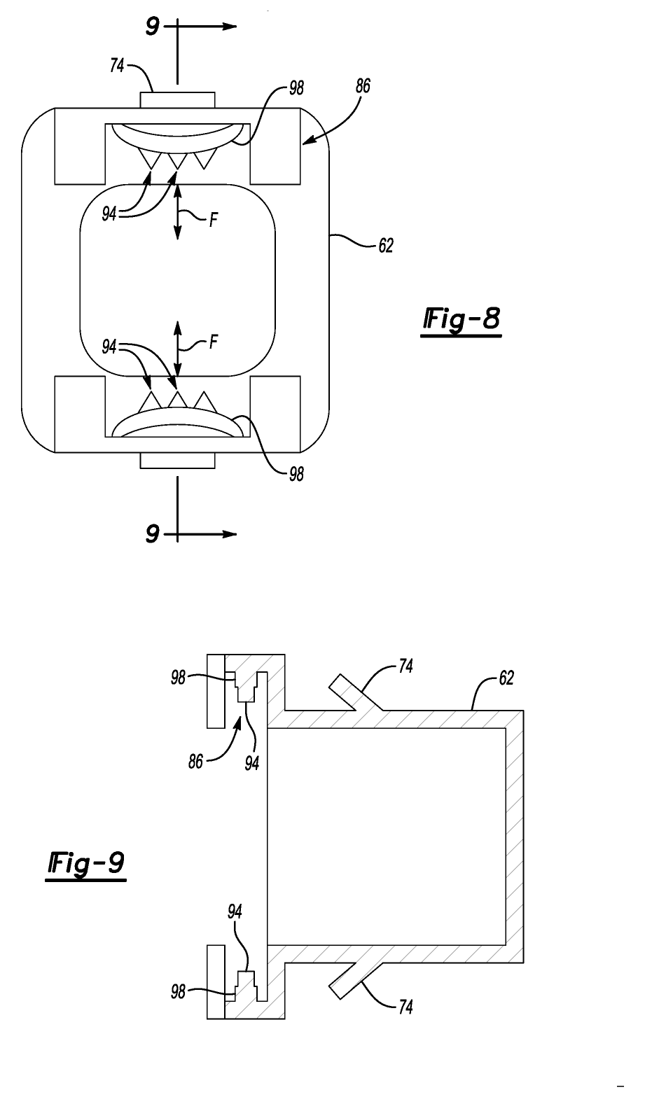

With reference now to FIGS. 5-9 and continuing reference to FIGS. 1-4, the example fastener assemblies 22 each include a grommet assembly 50 and a ball stud 54. The grommet assembly 50 holds the ball stud 54 when the fastener assembly 22 is in the engaged position. In this example, the ball stud 54 is secured to and extends from the B-side 44 of the first component 14. The grommet assembly 50 is secured to the second component 18. In another example, the grommet assembly 50 could be secured to the first component 14, and the ball stud 54 could extend from the second component 18.

The ball stud 54 can be moved to an engaged position with the grommet assembly 50 without direct access to the fastener assembly 22. The fastener assembly 22 can thus be considered a blind fastener assembly.

The grommet assembly 50 includes a grommet insert 58 and a grommet base 62. The grommet insert 58 includes a socket 66 that holds the ball stud 54 when the fastener assembly 22 is in the engaged position. The example socket 66 is circular. In other examples, the socket 66 could be elongated as shown by broken lines 68 in FIG. 5. The socket 66 could be elongated so the socket 66 is not used as a locator.

The grommet insert 58 includes raised areas 70 within the socket 66. The raised areas 70 retain the ball stud 54 within the socket 66.

The grommet base 62 includes snap tabs 74 that hold the grommet base 62 within an aperture 78 of the second component 18 to snap-fit the grommet base 62 within hold the grommet assembly 50 to the second component 18.

The grommet insert 58 includes a collar 82 that is received within a groove 86 provided by the grommet base 62. The grommet insert 58 is slidably adjustable within the groove 86 to one of a plurality of fixed positions.

In this example, the grommet insert 58 includes a plurality of insert teeth 90 and the grommet base 62 includes a plurality of base teeth 94. The plurality of base teeth 94 are biased into engagement with the plurality of insert teeth 90. The insert teeth 90 and the base teeth 94 can be considered ratchet teeth.

In this example, to bias the base teeth 94, the base teeth 94 are molded on a respective spring arm 98 of the grommet base 62. The spring arms 98, with the base teeth 94, can flex back and forth in a direction F. Biasing provided by the spring arm 98 presses the plurality of base teeth 94 into engagement with the plurality of insert teeth 90. Sufficient horizontal force applied to the grommet insert 58 can overcome the biasing force and flex the spring arms 98 such that the base teeth 94 disengage from the insert teeth 90 and the grommet insert 58 slides horizontally within the groove 86.

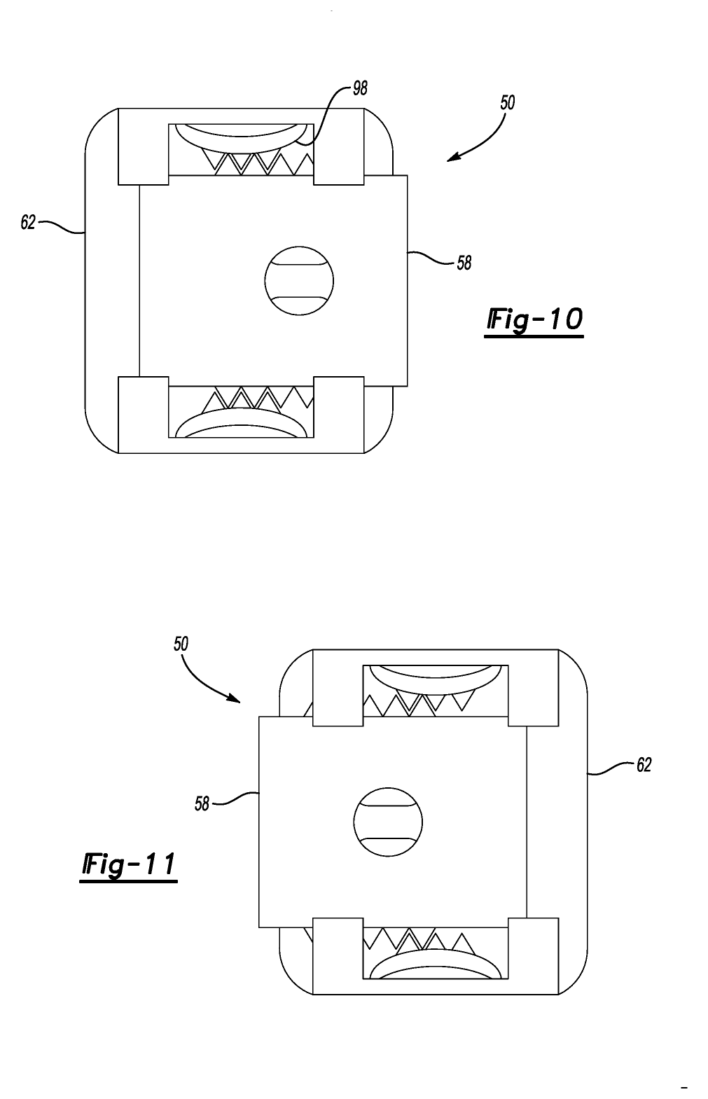

During assembly of the first component 14, after engaging the ball stud 54 within the grommet insert 58, and before engaging the threaded fasteners 40, an assembler can, for example, push the first component 14 horizontally toward a passenger side of the vehicle 10. The force exerted by the assembler can overcome the biasing force pressing the plurality of base teeth 94 into engagement with the plurality of insert teeth 90. Accordingly, the grommet insert 58 shifts from the fixed position of FIG. 5 to the fixed position of FIG. 10. This shifting can reduce the gap G on a passenger side of the first component 14 and increase the gap G on the driver side.

The shifting is in a direction transverse to a longitudinal axis of the ball stud 54 and transverse to the direction that the ball stud 54 is inserted into the socket 66. In this example, the grommet insert 58 receives the ball stud 54 in a first direction, which is forward in the vehicle 10. The shifting of the first component 14 is in a direction transverse to the first direction.

Similarly, after engaging the ball stud 54 within the grommet insert 58, and before engaging the threaded fasteners 40, the assembler could alternatively urge the first component 14 toward a driver side of the vehicle 10. The force applied to the first component 14 by the assembly can overcome the biasing force pressing the plurality of base teeth 94 into engagement with the plurality of insert teeth 90, and can shift the grommet insert 58 from the fixed position of FIG. 5 to the fixed position of FIG. 11. The ball stud 54 remains held within the grommet insert 58 as the ball stud 54 and the first component 14 shift toward the driver side of the vehicle 10. This shifting can reduce the gap G on a driver side of the first component 14 and increase the gap G on the passenger side.

In the past, fasteners have permitted joined components to slide a bit relative to one another before being fixed in an installed position. The sliding, however, was not between fixed positions. Thus, the sliding was not controlled until the components were fixed to each other in the installed position. The engagement between the base teeth 94 and the insert teeth 90 is sufficient to block sliding of the grommet insert 58 within the grommet base 62 if the assembler is not applying sufficient horizontally directed force to the first component 14.

Providing the fastener assemblies 22, which are slidably adjustable between fixed positions, can help to ensure that the first component 14 is held in a desired position until the threaded fasteners 40 can be engaged to secure the first component 14 to the second component 18 a fixed position.

In the exemplary embodiment, the base teeth 94 are molded on the spring arm 98, which is part of the grommet base 62. In another example, the grommet insert 58 could include a spring arm, and the plurality of insert teeth 90 could be disposed on that spring arm. Biasing force provided by the spring arm of the grommet insert 58 can bias the plurality of insert teeth 90 into engagement with the plurality of base teeth 94. In such an example, the insert teeth 90 are biased into engagement with the base teeth 94 rather than the base teeth 94 being biased into engagement with the insert teeth 90.

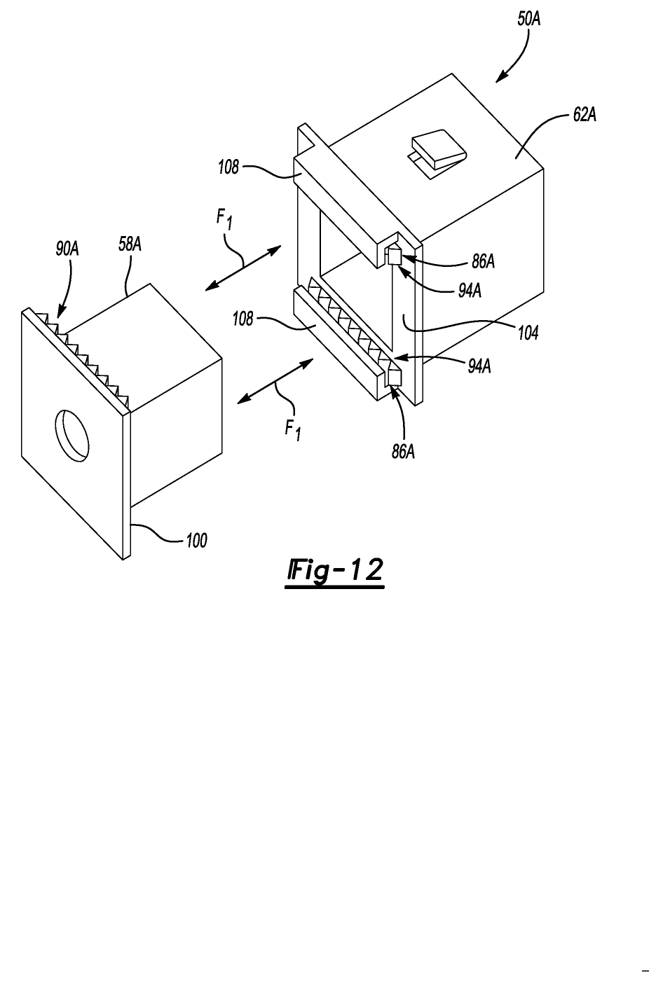

With reference to FIG. 12, in yet another exemplary embodiment, a grommet assembly 50A could include insert teeth 90A that project from a contact face 100 of a grommet insert 58A. When installed within a channel 86A of a grommet base 62A, the insert teeth 90A engage with corresponding base teeth 94A projecting from a contact face 104 of a grommet base 62A. Flanges 108 of the grommet base 62A can flex back and forth in direction F1 to permit the insert teeth 90A and the base teeth 94A to disengage when sliding the grommet insert 58A relative to the grommet base 62A is desired.

In the exemplary embodiments, the insert teeth 90, 90A and the base teeth 94, 94A are interlocking features that enable the grommet assemblies 50, 50A to adjust between the plurality of fixed positions. In other examples, other types of interlocking features could be used, such as dimples on one of the grommet base 62 or the grommet insert 58 received within corresponding recesses on the other of the grommet base 62 or the grommet insert 58. The recesses could be areas between dimples on the other of the grommet base 62 or the grommet insert 58.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An adjustable fastener assembly, comprising:
a grommet base; and
a grommet insert having a socket that holds a stud to secure the stud relative to the grommet insert, the grommet insert adjustable relative to the grommet base between a plurality of fixed positions.

2. The adjustable fastener assembly of claim 1, wherein the grommet base includes a plurality of base teeth and the grommet insert includes a plurality of insert teeth, the plurality of base teeth interlocking with the plurality of insert teeth to hold the grommet insert in one of the plurality of fixed positions.

3. The adjustable fastener assembly of claim 2, wherein one of the plurality of insert teeth or the plurality of base teeth is biased into engagement with the other of the plurality of insert teeth or the plurality of base teeth.

4. The adjustable fastener assembly of claim 1, wherein the grommet insert is slidably adjustable relative to the grommet base.

5. The adjustable fastener assembly of claim 1, wherein the socket receives the stud in a first direction, wherein the grommet insert is slidably adjustable relative to the grommet base in a second direction that is transverse to the first direction.

6. The adjustable fastener assembly of claim 1, wherein the stud is secured to a first component of a vehicle, wherein the grommet base and the grommet insert are secured to a second component of the vehicle, wherein the socket holding the stud secures the first component relative to the second component.

7. The adjustable fastener assembly of claim 6, wherein the first component is a trim panel.

8. The adjustable fastener assembly of claim 7, wherein the second component is a body panel of a vehicle.

9. The adjustable fastener assembly of claim 8, wherein the body panel is a liftgate body panel.

10. The adjustable fastener assembly of claim 8, wherein the grommet base is snap-fit within an aperture of the body panel.

11. The adjustable fastener assembly of claim 1, wherein a plurality of interlocking features of the grommet base are configured to interlock with a plurality of interlocking features of the grommet insert to hold the grommet insert in one of the plurality of fixed positions.

12. The adjustable fastener assembly of claim 1, wherein the grommet base includes at least one groove that slidably receives the grommet insert.

13. An adjustable fastener assembly, comprising:
a grommet assembly secured to a first component, the grommet assembly having a grommet base holding a grommet insert, the grommet insert slidable relative to the grommet base when the grommet insert is held by the grommet base, the grommet insert having a plurality of insert interlocking features that engage a plurality of base interlocking features to block sliding of the grommet insert relative to the grommet base; and
a stud secured to a second component, the stud held within a socket of the grommet insert and slidable with the grommet insert relative to the grommet base.

14. The adjustable fastener assembly of claim 13, wherein the plurality of insert interlocking features are a plurality of insert teeth, and the plurality of base interlocking features are a plurality of base teeth.

15. The adjustable fastener assembly of claim 13, wherein the stud is a ball stud.

16. The adjustable fastener assembly of claim 13, wherein the grommet base is snap-fit to the first component.

17. The adjustable fastener assembly of claim 13, wherein the plurality of insert interlocking features and the plurality of base interlocking features are biased into engagement with each other.

18. The adjustable fastener assembly of claim 13, wherein the plurality of insert interlocking features and the plurality of base interlocking features are disengaged when the grommet insert slides relative to the grommet base.

19. The adjustable fastener assembly of claim 13, wherein the grommet insert and the stud are slidable relative to the grommet base in a direction that is transverse to a longitudinal axis of the stud.

20. The adjustable fastener assembly of claim 13, wherein the first component is an exterior trim panel of a vehicle.
